(19) United States
(12) Patent Application Publication
(10) Pub. No.: US 2014/0268708 A1
(43) Pub. Date: Sep. 18, 2014

(54) ELECTRONIC CANDLE WITH LASER ENGRAVED FIGURES

(71) Applicant: CHIN-SHENG YANG, Tainan City (TW)

(72) Inventor: CHIN-SHENG YANG, Tainan City (TW)

(21) Appl. No.: 13/802,757

(22) Filed: Mar. 14, 2013

(51) Int. Cl. F21V 11/00; F21L 4/00

(52) U.S. Cl. CPC F21V 11/00; F21L 4/00
USPC 362/190

(57) ABSTRACT

The present invention provides an electronic candle with laser engraved figures comprising a main base having a power supply unit provided to receive a battery therein and electrically connected thereto to generate a power; a lighting unit provided on a top portion of the main base and electrically connected to the power supply unit of the main base; and a housing made of a plastic material in a transparent hollow tubular shape and comprising an opening on one end thereof and an engraved figure surface formed by laser engraving on a housing wall thereof; and wherein the housing covers an outer circumference of the lighting unit and is attached to the main base. Therefore, as the light generated by the lighting unit passes through the housing, the engraved figure surface of the housing is able to advantageously produce a unique visual effect with rich and layered designs of lighting.

### (a) TECHNICAL FIELD OF THE INVENTION

The present invention is related to a candle type decorative apparatus, in particular, to a decorative lighting apparatus with laser engraved figures.

### (b) DESCRIPTION OF THE PRIOR ART

As modern lights and lighting fixtures continues to evolve and develop, the traditional lighting of candles nowadays is being used for decoration purposes in such as special occasions or events while the appearances of candles have always been of column shapes without significant variations.

For traditional candles, the candle flame is known to be affected by its surrounding air and wind once lit, which is a concern to users as such flickering of candle flames in windy environment may either be blown off or may cause tipping off of the candle causing the hot candle wax to spill, leading to the occurrence of fire hazards or other dangerous accidents. There are now electronic candles introduced to the market for lighting and decorative purposes; nevertheless, the illumination provided by and the figures appeared on the outer shapes of such known electronic candles are in sufficient in terms of their visual and lighting effects. There is a need for an improved electronic candle capable of generating a light with great visual effects and desired illumination effects.

### SUMMARY OF THE INVENTION

Accordingly, the present invention provides an electronic candle with laser engraved figures comprising:

a main base having a power supply unit provided to receive a battery therein and electrically connected thereto to generate a power;

a lighting unit provided on a top portion of the main base and electrically connected to the power supply unit of the main base; and

a housing made of a plastic material in a transparent hollow tubular shape and comprising an opening on one end thereof and an engraved figure surface formed by laser engraving on a housing wall thereof; and wherein the housing covers an outer circumference of the lighting unit and is attached to the main base. Therefore, as the light generated by the lighting unit passes through the housing, the engraved figure surface of the housing is able to advantageously produce a unique visual effect with rich and layered designs of lighting.

### BRIEF DESCRIPTION OF THE DRAWINGS

FIG. 1 is a perspective view of the present invention;

FIG. 2 is an exploded view of the present invention;

FIG. 3 is a lateral cross sectional view of the present invention; and

FIG. 4 is a bottom perspective view of the present invention.

### DETAILED DESCRIPTION OF THE PREFERRED EMBODIMENTS

Please refer to FIG. 1 to FIG. 3, showing a preferred embodiment of an electronic candle with laser engraved figures of the present invention. As shown in the figure, the electronic candle with laser engraved figures of the present invention comprises:

a main base 1 having a power supply unit 11 provided to receive a battery therein and electrically connected thereto to generate a power; wherein a top portion of the main base 1 comprises a securement slot 12 and a bottom cap 13 attached to a bottom portion of the main base 1;

a lighting unit 2 comprising a circuit board 21 inserted into the securement slot 12 and electrically connected to the power supply 11; wherein the circuit board 21 comprises at least one lighting element 22 electrically connected thereto;

a housing 3 made of a plastic material in a transparent hollow tubular shape; wherein the housing 3 comprises an opening 31 on one end thereof and an engraved figure surface 32 formed by laser engraving on a housing wall thereof; and wherein the housing 3 covers an outer circumference of the lighting unit 2 and is attached to the main base 1.

As shown in FIG. 4, in an embodiment of the present invention, the main base 1 further comprises a switch 14 having one end electrically connected to the power supply unit 11 and another end electrically connected to the circuit board 21. The switch 14 is used for controlling on and off states of the lighting elements 22 of the lighting unit 2. The top portion of the housing 3 comprises a through-hole 34, and two lighting elements 22 spaced apart from each other are electrically connected to the circuit board 21; wherein one of the lighting elements 22 is provided on a top of the circuit board 21 and is partially exposed from the through-hole 34. The through-hole 34 is configured to receive a light shield 4 arranged thereon; wherein the light shield 4 is of a hollow shape of a candle flame. In this embodiment, the two lighting elements 22 are color LED lights and the lighting unit 2 further comprises an integrated circuit board 22 for controlling a color changing sequence and an illumination time of the LED lights such that the two lighting elements 22 emit lights to shine toward the engraved figure surface 32 and then to pass through the housing 3 in order to generate an atmospheric lighting for decorative purposes.

The engraved figure surface 32 can be provided on either an inner side or outer side of the housing wall of the housing 3. The figures can be formed by a method of vacuum plating or coating to coat an inner layer thereon, followed by laser engraving to cut out areas of desired figures in order to form hollow and figure zones that are transparent to other inner layers and capable of allowing light to pass therethrough and such that the engraved figure surface 32 is formed; furthermore, the inner layer may also comprise a color layer covered thereon in order to provide a rich visual presentation. In addition, when the engraved figure surface 32 is provided on an outer side of the housing wall, the inner side of the housing wall can be provided with a light-transmissive decorative layer 33 covered thereon; wherein the light-transmissive decorative layer 33 can a layer formed by transparent gel mixed with light-reflective slats or particles or can be formed by surface sand-blasting or frosting treatment methods in order to advantageously achieve a unique visual effect with rich and layered designs and an active illumination.

The term of “laser engraving” refers to, but not limited to, a process of engraving with a laser light shone on a surface of a target object. Based on the power of the laser and the density of the laser light used, various effects and engraving outcomes can be achieved. The laser engraving can also be used to atomize a coating or plating surface of a target object such that the original or base color of the object can be revealed.

What is claimed is:

1. An electronic candle with laser engraved figures, comprising:
a main base having a power supply unit provided to receive a battery therein and electrically connected thereto to generate a power;
a lighting unit provided on a top portion of said main base and electrically connected to said power supply unit of said main base; and
a housing made of a plastic material in a transparent hollow tubular shape and comprising an opening on one end thereof and an engraved figure surface formed by laser engraving on a housing wall thereof; and wherein said housing covers an outer circumference of said lighting unit and is attached to said main base.

2. The electronic candle with laser engraved figures according to claim 1, wherein said lighting unit comprises a circuit board electrically connected to at least one lighting element; and said circuit board is electrically connected to said power supply unit.

3. The electronic candle with laser engraved figures according to claim 1, wherein said top portion of said housing comprises a through-hole for receiving a light shield arranged thereon.

4. The electronic candle with laser engraved figures according to claim 1, wherein said engraved figure surface is provided on an outer side of said housing wall of said housing.

5. The electronic candle with laser engraved figures according to claim 4, wherein an inner side of said housing wall of said housing comprising a light-transmissive decorative layer covered thereon.

6. The electronic candle with laser engraved figures according to claim 1, wherein said engraved figure surface is provided on an inner side of said housing wall of said housing.

7. The electronic candle with laser engraved figures according to claim 1, wherein said main base comprises a switch having one end electrically connected to said power supply unit to control on and off states of said lighting unit.
